(19) United States
(12) Patent Application Publication
(10) Pub. No.: US 2026/0077331 A1
(43) Pub. Date: Mar. 19, 2026

(54) IMPROVEMENTS IN OR RELATING TO MONITORING OF FISCHER-TROPSCH CHEMICAL REACTORS

(71) Applicant: JOHNSON MATTHEY DAVY TECHNOLOGIES LIMITED, London (GB)

(72) Inventors: Jay Simon CLARKSON, Stockton-On-Tees (GB); Andrew James COE, London (GB); Andrew FISH, Billingham (GB)

(21) Appl. No.: 19/109,825

(22) PCT Filed: Oct. 20, 2023
(86) PCT No.: PCT/GB2023/052725

§ 371 Date: Mar. 7, 2025

(30) Foreign Application Priority Data
Nov. 8, 2022 (GB) 2216580.7

(51) Int. Cl. B01J 19/00; B01J 8/00; B01J 8/04

(52) U.S. Cl. CPC B01J 19/0033; B01J 8/001; B01J 8/0492; B01J 2208/00548; B01J 2208/00637; B01J 2208/00707; B01J 2208/021; B01J 2208/024

(57) ABSTRACT

A chemical reactor system comprising: a) a main reactor comprising: i) a reaction chamber containing catalyst, ii) an inlet for feeding feedstock gas from a feedstock source into the reaction chamber to contact the catalyst, and iii) an output for reaction products produced in the reaction chamber from reaction of the feedstock gas in the presence of the catalyst; and b) a reaction testing module comprising: i) an inlet configured to receive feedstock gas from the same feedstock source supplying feedstock gas to the main reactor, and ii) at least one test reactor in fluid communication with the inlet and each comprising a reaction chamber containing catalyst, wherein the main reactor is a Fischer Tropsch reactor containing a Fischer Tropsch catalyst.

### FIELD

The present disclosure relates to improvements in monitoring of Fischer-Tropsch chemical reactors. In particular, the disclosure relates to a chemical reactor system, a method for detecting poisoning of a catalyst in a reaction chamber, a reaction testing module configured for connection to a feedstock source of a main reactor, and a micro-reactor configured to be removably inserted into a reaction testing module.

The present disclosure is applied to the Fischer-Tropsch process.

### BACKGROUND

The Fischer-Tropsch process is a collection of chemical reactions that converts a mixture of carbon monoxide and hydrogen into liquid hydrocarbons. These reactions occur in a reaction chamber in the presence of metal catalysts, typically at temperatures of 150-300° C. and pressures of one to several tens of atmospheres. The Fischer-Tropsch process involves a series of chemical reactions that produce a variety of hydrocarbons, ideally having the formula (CₙH₂ₙ₊₂). The more useful reactions produce alkanes as follows:

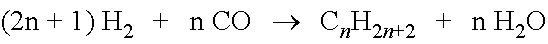

where n is typically 1-100, or higher. The formation of methane (n=1) is unwanted. Most of the alkanes produced tend to be straight-chain, suitable to be upgraded to produce middle-distillate fuels such as diesel and jet fuel. In addition to alkane formation, competing reactions give small amounts of alkenes, as well as alcohols and other oxygenated hydrocarbons. The Fischer-Tropsch reaction is a highly exothermic reaction due to a standard reaction enthalpy (ΔH) of −165 KJ/mol CO combined.

A feedstock gas feed, for example a synthesis gas (syngas) feed, to a Fischer-Tropsch reactor can be derived from a number of feedstock sources; for example, natural gas via steam reforming and/or auto-thermal reforming, municipal solid waste and biomass via high-temperature gasification or carbon dioxide and hydrogen via a reverse water-gas shift. The syngas produced by these processes typically contains ppm levels of poisons or impurities, such as hydrogen cyanide and ammonia, which, if they are allowed to reach the Fischer-Tropsch catalyst in the reactor, may damage the catalyst. For example, relatively high levels of hydrogen cyanide or ammonia may result in acute poisoning of the catalyst in a short period of time. Alternatively, relatively low levels of hydrogen cyanide or ammonia, while not poisoning the catalyst in the short term, can lead to gradual deactivation of the catalyst over time. Poisoning and deactivation of the catalyst leads to reduced efficiency of operation and may necessitate taking the reactor offline to allow for replacement and/or re-generation of the catalyst. This in turn leads to increased operation costs that further negatively affect the economic viability of the process.

Therefore, ideally the hydrogen cyanide and ammonia (as well as any other relevant poisons or impurities that may be present) are removed down to single-digit ppb levels before the syngas reaches the Fischer-Tropsch reactor. To remove these species from the syngas, a purification train may be established upstream of the reactor. For example, the purification train may comprise one or more purification beds that treat the syngas. In some examples, the purification may comprise the hydrogen cyanide being converted to ammonia via hydrolysis and then the ammonia being removed using a wet scrubber.

However, despite the use of upstream purification, there still remains a risk of contamination of the catalyst in the reactor by poisons and impurities in the feedstock gas, for example, in a syngas. For example, the purification beds in the purification train may malfunction or become saturated. For example, an unexpected poison or impurity may be present for which the purification train is not configured to remove.

The present disclosure seeks to tackle at least some of the problems associated with the prior art or at least to provide a commercially acceptable alternative solution thereto.

### SUMMARY

In a first aspect of the present disclosure there is provided a chemical reactor system comprising:
a) a main reactor comprising:
   i) a reaction chamber containing catalyst,
   ii) an inlet for feeding feedstock gas from a feedstock source into the reaction chamber to contact the catalyst, and
   iii) an output for reaction products produced in the reaction chamber from reaction of the feedstock gas in the presence of the catalyst;
   and
b) a reaction testing module comprising:
   i) an inlet configured to receive feedstock gas from the same feedstock source supplying feedstock gas to the main reactor, and
   ii) at least one test reactor in fluid communication with the inlet and each comprising a reaction chamber containing catalyst,
wherein the main reactor is a Fischer-Tropsch reactor containing a Fischer-Tropsch catalyst.

In some preferred examples, the reaction testing module further comprises:
iii) an analyser configured to determine a level of catalytic activity of the catalyst within the at least one test reactor by analysis of gas exiting or derived from the reaction chamber of the at least one test reactor.

For example, the analyser may determine the level of catalytic activity by analysis of the syngas components of the gas. Such analysis may include, for example, measurement of a value of and/or a rate of change of one or more parameters that may include, for example, CO conversion, methane selectivity, and C5+ productivity.

In some examples, the analyser comprises a mass spectrometer or gas chromatograph.

In some preferred examples, the analyser is configured to generate an alert on detection of a decrease in the level of catalytic activity of the catalyst within the at least one test reactor indicative of poisoning of the catalyst within the at least one test reactor.

In some examples, the chemical reactor system further comprises a controller configured to take corrective action on generation of the alert by the analyser.

Preferably, the corrective action comprises altering a composition of the feedstock gas, decreasing a flow rate of the feedstock gas into the reaction chamber of the main reactor, or preventing feeding of the feedstock gas into the reaction chamber of the main reactor.

In some examples, the reaction testing module further comprises a separator for separating the gas exiting the reaction chamber of the at least one test reactor into one or more wax and/or liquid and/or gas fractions.

In some examples, the wax and liquid fractions are separated into a first product stream comprising wax products and a second product stream comprising light hydrocarbon products and water.

In some examples, the catalyst in the reaction chamber of the at least one test reactor is the same catalyst as present in the reaction chamber of the main reactor.

In some other examples, the catalyst in the reaction chamber of the at least one test reactor is one or more different catalysts to that present in the reaction chamber of the main reactor.

In some preferred examples, the at least one test reactor comprises a plurality of test reactors arranged in parallel.

Preferably one or more, more preferably each, of the plurality of test reactors is removable from the reaction testing module while a remainder of the plurality of test reactors remains in operation.

In some examples, the at least one test reactor comprises three, four, five, six or more test reactors.

In some examples, each of the at least one test reactors comprises a micro-reactor having:
i) a reaction chamber volume less than 250 cm³, optionally less than 200 cm³, optionally less than 150 cm³, optionally less than 100 cm³, optionally less than 50 cm³; and/or
ii) a reaction chamber containing less than 25 grams of catalyst, optionally less than 20 g of catalyst, optionally less than 15 g of catalyst, optionally less than 10 g of catalyst, optionally less than 5 g of catalyst; and/or
iii) a reaction chamber length of 30 to 120 cm and/or a reaction chamber diameter of 5 to 20 mm.

In some examples, the reaction testing module further comprises a heated chamber housing the at least one test reactor. Beneficially, this may permit the operating conditions of the catalyst in the at least one test reactor to closely match that of the catalyst in the main reactor. In some examples, one or more, more preferably each, test reactor is independently controlled via an electric heating block and a temperature profile for the or each test reactor(s) is measured. For example, a catalyst bed temperature profile may be measured using a multipoint thermocouple housed in a central thermowell. Alternatively, temperatures may be measured by thermocouples housed on the wall of a test reactor.

Preferably, the reaction testing module is configured as a sidestream unit arranged in parallel to a gas flow path through the main reactor.

In some examples, the chemical reactor system further comprises a flow splitter downstream of the feedstock source and upstream of the main reactor, the flow splitter receiving the feedstock gas from the feedstock source; the flow splitter comprising a first outlet for feeding the reaction chamber of the main reactor and a second outlet for feeding the at least one test reactor of the reaction testing module.

In some preferred examples, the reaction testing module is configured to combine gas exiting the reaction testing module with gas exiting the main reactor at a point downstream of the reaction chamber of the main reactor, such that gas passing through the reaction testing module by-passes at least the reaction chamber of the main reactor.

In preferred examples, the pipework of the chemical reactor system exposed to the feedstock gas is internally coated with a protective coating to prevent retention of poison components on surfaces of the pipework. The protective coating may be applied to the pipework upstream of the reaction testing module as well as the internal pipework of the reaction testing module.

In accordance with the present specification, the main reactor is a Fischer-Tropsch reactor containing a Fischer-Tropsch catalyst.

In a second aspect of the present disclosure there is provided a method for detecting poisoning of a catalyst in a reaction chamber, the method comprising:
a) operating a main reactor, comprising the reaction chamber containing the catalyst, by passing feedstock gas through the reaction chamber to contact the catalyst to produce reaction products from reaction of the feedstock gas in the presence of the catalyst;
b) simultaneously operating a reaction testing module by passing feedstock gas through at least one test reactor of the reaction testing module, each test reactor comprising a reaction chamber containing the same catalyst as present in the reaction chamber of the main reactor or a suitable equivalent thereof; and
c) using an analyser to determine a level of catalytic activity of the catalyst within the at least one test reactor by analysis of gas exiting the reaction chamber of the at least one test reactor and/or analysis of the catalyst of the at least one test reactor,
wherein the main reactor is a Fischer-Tropsch reactor containing a Fischer-Tropsch catalyst.

Preferably, the feedstock gas feeding the reaction chamber of the main reactor and the feedstock gas feeding the at least one test reactor of the reaction testing module are from the same feedstock source.

In some preferred examples, a gas flow from the feedstock source is split into a first flow that feeds the reaction chamber of the main reactor and a second flow that feeds the at least one test reactor of the reaction testing module.

In some preferred examples, analysis of the gas exiting the reaction chamber of the at least one test reactor is carried out in real time during operation of the main reactor.

In some examples, the analysis of the gas exiting the reaction chamber of the at least one test reactor is performed by a mass spectrometer or gas chromatograph.

In some examples, the gas exiting the reaction chamber of the at least one test reactor is dried and/or cooled before being passed to the mass spectrometer or gas chromatograph.

In some preferred examples, the method further comprises generating an alert on detection of a decrease in the level of catalytic activity of the catalyst within the at least one test reactor indicative of poisoning of the catalyst within the at least one test reactor.

In some preferred examples, the method further comprises taking corrective action on generation of the alert by the analyser.

Preferably, the corrective action comprises altering a composition of the feedstock gas, decreasing a flow rate of the feedstock gas into the reaction chamber of the main reactor, or preventing feeding of the feedstock gas into the reaction chamber of the main reactor.

In some examples, the catalyst in the reaction chamber of the at least one test reactor is the same catalyst as present in the reaction chamber of the main reactor.

In some other examples, the catalyst in the reaction chamber of the at least one test reactor is one or more different catalysts to that present in the reaction chamber of the main reactor.

In some preferred examples, the at least one test reactor comprises a plurality of test reactors arranged in parallel.

In some preferred examples, analysis of the catalyst of the at least one test reactor is performed at a remote location by removal of the test reactor from the reaction testing module.

The reaction testing module may be configured to permit analysis of the gas exiting the reaction chamber of the at least one test reactor in real time during operation of the main reactor and also to permit post-mortem analysis for the catalyst by removal of the test reactor from the reaction testing module.

In some examples, the analysis of the catalyst comprises elemental analysis of the catalyst to identify build-up of poisons on the catalyst.

In some preferred examples, the at least one test reactor comprises a plurality of test reactors arranged in parallel and the analysis of the catalyst comprises periodic removal of successive test reactors to enable trends in poison build-up on the catalyst to be identified.

In some examples, the method further comprises heating the at least one test reactor in a heated chamber.

In accordance with the present specification, the main reactor is a Fischer Tropsch reactor containing a Fischer Tropsch catalyst.

The present disclosure also provides a reaction testing module configured for connection to a feedstock source of a main reactor, the reaction testing module comprising:
i) an inlet configured to receive feedstock gas from the feedstock source; and
ii) a plurality of test reactors in fluid communication with the inlet and arranged in parallel, each test reactor comprising a reaction chamber containing catalyst.

In some preferred examples, the reaction testing module further comprises an analyser configured to determine a level of catalytic activity of the catalyst within the plurality of test reactors by analysis of gas exiting the reaction chambers the plurality of test reactors.

In some examples, the reaction resting module further comprises a heated chamber housing the at least one test reactor.

The catalyst in each of the reaction chambers is a Fischer Tropsch catalyst.

The present disclosure also provides a micro-reactor configured to be removably inserted into a reaction testing module, the micro-reactor comprising:
i) a reaction chamber volume less than 250 cm³, optionally less than 200 cm³, optionally less than 150 cm³, optionally less than 100 cm³, optionally less than 50 cm³; and/or
ii) a reaction chamber containing less than 25 grams of catalyst, optionally less than 20 g of catalyst, optionally less than 15 g of catalyst, optionally less than 10 g of catalyst, optionally less than 5 g of catalyst.

In some examples, the reaction chamber has a length of 30 to 120 cm and/or a diameter of 5 to 20 mm.

The catalyst in the reaction chamber is a Fischer-Tropsch catalyst.

In some examples, the reaction chamber of the micro-reactor is pre-charged with the catalyst and sealed prior to insertion the reaction testing module. When the catalyst has an oxidic form which requires activation by reduction, preferably the catalyst is activated prior to pre-charging. This can make the sidestream unit easier to operate, eliminate the requirement to activate the catalyst on a site, save time and reduce equipment complexity.

Beneficially, these aspects of the present disclosure may permit the detection and/or analysis of contamination of the catalyst by poisons and impurities in the feedstock gas.

Where the system is configured for detection and/or analysis of contamination of the catalyst by poison and impurities it will most preferably be the case that the catalyst in the reaction chamber of the at least one test reactor is the same catalyst as present in the reaction chamber of the main reactor. In this way a suitable correspondence can be ensured between the impact on the catalyst of the main reactor subjected to the feedstock gas and the impact on the catalyst in the reaction testing module.

A sudden decrease in the activity of the catalyst inside the at least one test reactor may, for example, be used as an indication of higher than expected levels of poisons or other contaminants in the feedstock gas.

Beneficially, since each of the test reactors may contain a very much smaller weight/volume of catalyst than present in the main reactor, the reduction in catalytic activity of a poisoning event may be detectable much more quickly compared to the monitoring of the activity of the catalyst in the main reactor. For example, in the main reactor a poisoning event may initially preferentially affect the catalyst closest to the inlet of the feedstock gas. However, the overall catalytic activity of the reactor may initially mask this poisoning and the gas output from the main reactor may appear largely unaffected due the large volume of catalyst that initially remains un-poisoned. By the time the reduction in the total catalytic activity of the main reactor is detected it may be the case that significant quantities of catalyst towards the inlet end will be poisoned and need to be replaced or regenerated.

The fast response time of the catalyst in the at least one test reactor may also enable the detection of transient periods of poisoning. During a transient event, the feedstock gas to the main reactor may be diverted to flare or shut off while still feeding the reaction testing module so that it can be assessed when the transient poisoning event has passed.

The reaction testing module may function as a warning sensor for the presence of poisons or other contaminants in the feedstock gas. Beneficially the use of the reaction testing module may permit intervention to take place quickly and so protect the larger volume of catalyst present in the reaction chamber of the main reactor.

Preferably, the instigation of a corrective action may be automatic or semi-automatic and may be instigated without human-interaction. Alternatively, an alert may be presented to a human operator of the reactor (e.g., by audible and/or visuals alert) prompting them to instigate the corrective action.

Use of the reaction testing module may provide benefits during all phases of the operation of the main reactor. For example, monitoring of the catalytic activity may be carried out for some or, preferably all, of the period of operation of the main reactor. The reaction testing module may also beneficially be used during a commissioning stage, e.g. during start-up of the main reactor. For example, during start-up the feedstock gas may be sent only to the reaction testing module for a period of time before the feedstock gas is sent to the main reactor. Thus, the reaction testing module may be used to ensure that the feedstock gas is within specification before exposing the catalyst in the man reactor to the feedstock gas. For example, by confirming an expected performance of the catalyst in the test reactor(s), thus avoiding damaging the catalyst in the main reactor at its start of life.

Additionally, the reaction testing module may be used to enable assessment of new catalyst formulations under conditions closely matched to that in the main reactor, but advantageously only requiring a small volume of catalyst and without requiring any changes to the main reactor.

For example, the system may be configured such that the catalyst in the reaction chamber of the at least one test reactor is one or more different catalysts to that present in the reaction chamber of the main reactor. In this way the test reactor(s) may be used to assess or screen one or more new catalyst candidates for the process and/or monitor and assess the vulnerability of one or more new catalyst candidates to potential poisoning events during ‘real-world’ conditions which may produce more accurate and informative results compared to small-scale lab-based testing. Beneficially the use of the reaction testing module as a screening/testing aid avoids the need to reconfigure the main reactor with a new catalyst, a process that would be very expensive in time and materials, and would only permit one catalyst at a time to be assessed.

In one mode of operation, the gas output from each of the at least one test reactors may be combined before being passed to the analyser. However, in a preferred mode of operation, the gas output from each of the at least one test reactors is analysed separately. For example, the output from a first test reactor may be analysed for a first period of time, followed by analysing the output from a second test reactor for a second period of time, etc.

Beneficially, the provision of a plurality of test reactors may enable the periodic removal of test reactors over the duration of the operation of the main reactor. Analysis of the catalyst in the test reactors over time may permit a better understanding of poison build up on the catalyst in the test reactors and the main reactor. Since poisoning of the catalyst may in some cases be a slow process, the periodic removal and analysis of the catalyst from the reaction testing module may allow for trends in poisoning to be established. Beneficially, the use of the reaction testing module means that the main reactor may be left undisturbed and prevents the need to shut down the main reactor to withdraw a sample of the catalyst from within the main reactor.

Further, the use and analysis of multiple test reactors may allow for increased statistical confidence that a poisoning event of the catalyst is occurring or has occurred.

The analysis may be performed in the vicinity of the main reactor or the test reactor may be sent to another location for analysis.

The type of poisons and contaminants built up on the catalyst may, for example, be identified by elemental analysis of the catalyst. Beneficially, analysis of the catalyst itself may overcomes difficulties in analysing ppb levels of poisons and contaminants directly in feedstock gas. In addition, analysis of the catalyst may permit detection of poisons and contaminants not traditionally analysed for in the feedstock gas.

The parallel arrangement of the test reactors may be used to ensure that all test reactors present in the reaction testing module are exposed to the same feedstock gas and for the same duration (or at least until a test reactor is optionally selectively removed for post-mortem analysis). Additionally, the parallel arrangement may permit one test reactor to be removed while the other test reactors remain operational.

In the present disclosure the main reactor is a Fischer Tropsch reactor containing a Fischer Tropsch catalyst. As such, in the following, the disclosure will be described, by way of example, with respect to a Fischer-Tropsch process and reactor. However, it will be appreciated that the systems, methods and apparatus of the present disclosure may be applied to other processes and reactors. In other examples, the main reactor may be configured for methanol synthesis, water gas shift, etc.

The catalyst of the main reactor may be provided in different forms as known in the art. For example, the catalyst may be provided as one or more beds of catalyst. The beds may be fluidised beds or fixed beds or a combination thereof. For example, the main reactor may be a fluidised-bed reactor or a fixed-bed reactor. Alternatively, the catalyst may be housed in a plurality of catalyst carriers that are received within reactor tubes of the main reactor. For example, the main reactor may be a tubular reactor. WO2011/048361, WO2012/136971, WO2016/050520 and WO2022064214A1, the contents of which are herein incorporated by reference in their entirety, describe some examples of catalyst carriers configured for use in tubular reactors.

### BRIEF DESCRIPTION OF THE DRAWINGS

Embodiments of the present disclosure will now be described, by way of example only, with reference to the accompanying drawings, in which:

FIG. 1 is a diagram illustrating a first example of a chemical reactor system according to the present disclosure;

FIG. 2 is a diagram illustrating a second example of a chemical reactor system according to the present disclosure;

FIG. 3 is a diagram illustrating a third example of a chemical reactor system according to the present disclosure; and

FIG. 4 is a schematic illustration of a reaction testing module of the third example.

### DETAILED DESCRIPTION

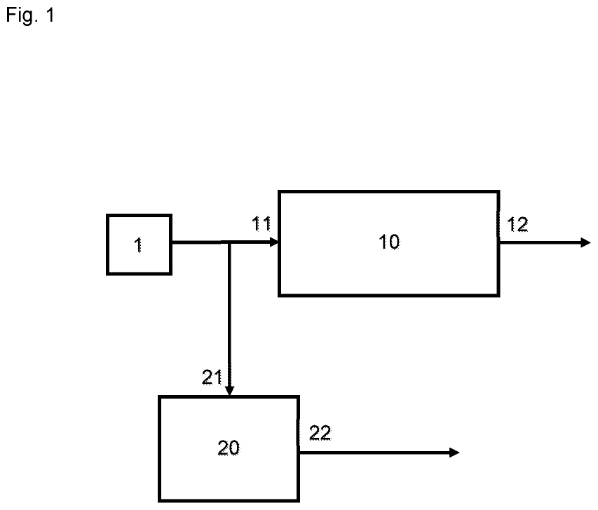

FIG. 1 shows a schematic of a first example of a chemical reactor system according to the present disclosure. The system comprises a main reactor 10 and a reaction testing module 20 both of which are fed with a feedstock gas from a common feedstock source 1.

The main reactor 10 comprises a reaction chamber containing catalyst, an inlet 11 for feeding feedstock gas from the feedstock source 1 into the reaction chamber to contact the catalyst, and an output 12 for reaction products produced in the reaction chamber from reaction of the feedstock gas in the presence of the catalyst.

The output 12 from the main reactor 10 may feed one or more downstream modules (not shown) configured for further processing, recycling or use. For example, the reaction products may comprise or consist of a liquid and gas phase as it exits the main reactor 10 which is then cooled downstream and separated into wax, liquid and gas phases. The wax phase may comprise heavier hydrocarbons, e.g. having a C10-C100 or more chain length or higher. The liquid phase may comprise lighter hydrocarbons and/or water fractions. The gas phase may be dry or have some residual moisture content.

The reaction testing module 20 comprises an inlet 21 configured to receive feedstock gas from the same feedstock source 1 supplying feedstock gas to the main reactor 10, and at least one test reactor in fluid communication with the inlet 21 and each comprising a reaction chamber containing catalyst. The catalyst may be the same catalyst as present in the reaction chamber of the main reactor 10 or a different catalyst.

The reaction testing module 20 may have an output 22 for reaction products produced in the reaction chamber(s) of the at least one test reactors.

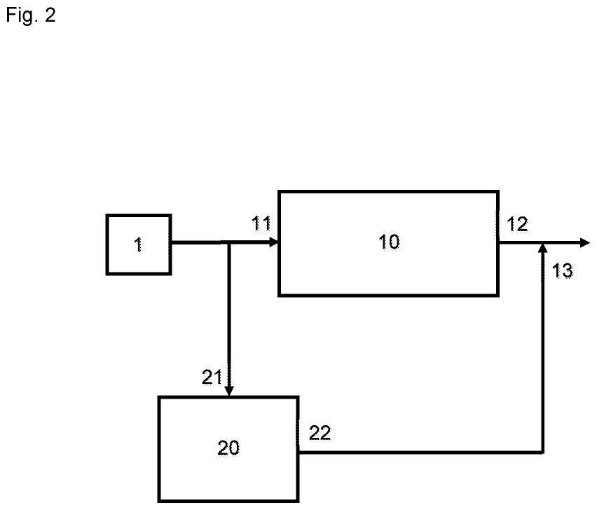

FIG. 2 shows a schematic of a second example of a chemical reactor system according to the present disclosure. This example is the same as the first example except that the output 22 of the reaction testing module 20 is fed back to join with the feed from the output 12 of the main reactor at point 13. This may beneficially improve the system efficiency by allowing for simplified downstream processing of the reaction products with a single set of modules, e.g. coolers, separators, etc.

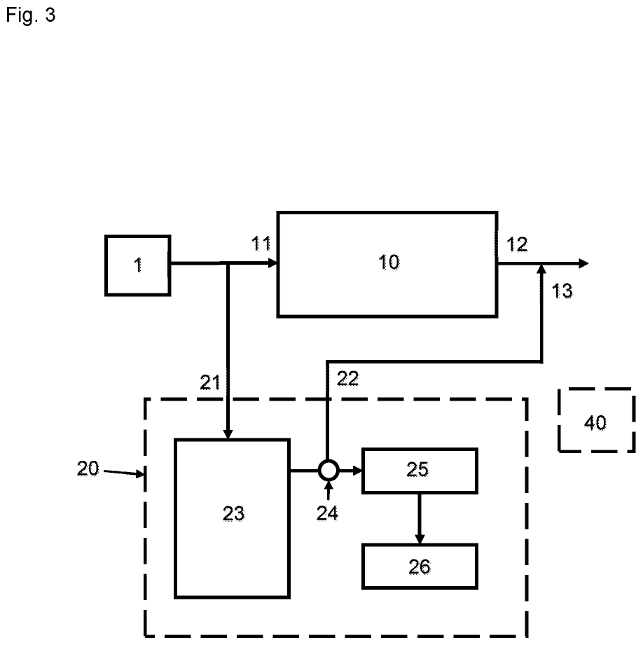

FIG. 3 shows a schematic of a third example of a chemical reactor system according to the present disclosure. This example is similar to the preceding examples. The at least one test reactors are designated with reference 23 and receive the feedstock gas from input 21. The reaction testing module 20 further comprises a separator 25 and an analyser 26. The analyser 26 may comprise a mass spectrometer or gas chromatograph.

The separator 25 may be configured to obtain a gas fraction from the reactant products output from the one or more test reactors 23 and pass this to the analyser 26. The separator 25 may comprise means for cooling the reactant products and/or separating them into wax and/or liquid and/or gas fractions. For example, the separator 25 may comprise one or more knock-out pots. A first knock-out pot may be provided for removing a wax fraction and a heavier HC fraction. A subsequent second knock-out pot may be provided for removing a lighter HC fraction and/or water. Preferably, the gas fraction passed to the analyser 26 comprises a dry gas.

The analyser 26 may be configured to determine a level of catalytic activity of the catalyst within the at least one test reactor 23 by analysis of the gas received from the separator 25. For example, the analyser may be configured to determine catalytic activity by calculation of performance parameters such as CO conversion, methane selectivity, product selectivity, e.g. Cn, suitably C5+ selectivity, paraffin and olefin selectivity, and productivity, e.g. C5+ productivity.

The system may further comprise a controller 40 configured to take corrective action on generation of the alert by the reaction testing module 20, e.g. by the analyser 26. The corrective action may comprise altering a composition of the feedstock gas, decreasing a flow rate of the feedstock gas into the reaction chamber of the main reactor 10, or preventing feeding of the feedstock gas into the reaction chamber of the main reactor 10, e.g. by diverting to flare or shutting off the feed entirely. The controller 40 may also be configured to increase the temperature of one or more of the test reactors to maintain a target performance parameter such that a rate of deactivation of the catalyst can be quantified. For example, the rate of deactivation may be quantified in terms of the extra temperature required to maintain carbon monoxide conversion at the target level.

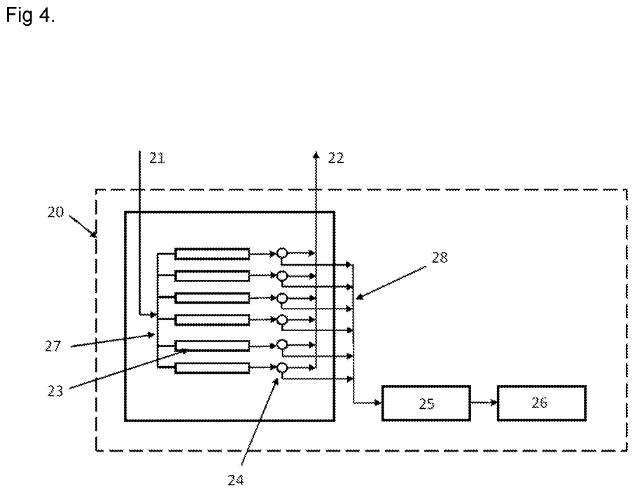

As shown schematically in FIG. 4, the reaction testing module 20 of the third example (or any of the other examples) may comprise a plurality of test reactors 23 arranged in parallel.

The illustrated example shows six test reactors 23 in parallel.

The test reactors 23 may be fed by a common inlet manifold 27. An isolation valve (not shown), for example a solenoid valve, may be provided upstream of each test reactor 23 to permit gas flow to each test reactor 23 to be selectively shut off to permit purging, maintenance and/or removal of the test reactor 23.

An outlet from each of the test reactors 23 may be fed into a common outlet manifold 28. A tee-off valve 24 may be interposed between each of the test reactors 23 and the common outlet manifold 28. The tee-off valves 24 may function to selectively direct gas exiting each test reactor 23 either to the common outlet manifold 28 or to the output 22 of the reaction testing module 20.

The common outlet manifold 28 may feed the separator 25 of the reaction testing module 20.

Each of the test reactors 23 may be removable from the reaction testing module 20 while a remainder of the test reactors 23 remain in operation.

Each test reactor 23 may comprise a micro-reactor having:
i) a reaction chamber volume less than 250 cm³, optionally less than 200 cm³, optionally less than 150 cm³, optionally less than 100 cm³, optionally less than 50 cm³; and/or
ii) a reaction chamber containing less than 25 grams of catalyst, optionally less than 20 g of catalyst, optionally less than 15 g of catalyst, optionally less than 10 g of catalyst, optionally less than 5 g of catalyst.

The reaction testing module 20 may further comprise a heated chamber housing the test reactor 23. For example, an oven or other heated chamber may be provided in order to maintain the test reactors 23 at a suitable elevated temperature.

The pipework of the chemical reactor system exposed to the feedstock gas may be internally coated with a protective coating to prevent retention of poison components on surfaces of the pipework. The protective coating may be applied to the pipework upstream of the reaction testing module 20 as well as the internal pipework of the reaction testing module 20. In some examples, a silicon coating may be applied where required, especially to any stainless steel pipework present. In one non-limiting example SilcoNert® coating from SilcoTek® of Bellefonte, PA, USA may be used.

In use, the reaction testing module 20 may enable a method for detecting poisoning of the catalyst in the reaction chamber of the main reactor 10. The method comprises:
a) operating the main reactor 10, which comprises the reaction chamber containing the catalyst, by passing the feedstock gas through the reaction chamber to contact the catalyst to produce reaction products from reaction of the feedstock gas in the presence of the catalyst;
b) simultaneously operating the reaction testing module 20 by passing feedstock gas through the test reactors 23, each test reactor 23 comprising a reaction chamber containing catalyst; and
c) using the analyser 26 to determine a level of catalytic activity of the catalyst within the test reactors 23 by analysis of gas exiting or derived from the reaction chamber of the test reactor 23 and/or analysis of the catalyst of the test reactors 23.

Analysis of the gas exiting or derived from the reaction chamber of the test reactors 23 may be carried out in real time during operation of the main reactor 10.

The gas exiting or derived from the reaction chamber of the test reactor 23 may be dried and/or cooled by the separator 25 before being passed to the analyser 26, e.g. the mass spectrometer or gas chromatograph.

The controller 40 may generate an alert on detection of a decrease in the level of catalytic activity of the catalyst within the test reactors 23 indicative of poisoning of the catalyst within the test reactor 23. This may be used as an analogue for detecting poisoning of the catalyst of the main reactor 10.

The detection or generation of the alert may instigate the taking of corrective action, such as altering a composition of the feedstock gas, decreasing a flow rate of the feedstock gas into the reaction chamber of the main reactor 10, or preventing feeding of the feedstock gas into the reaction chamber of the main reactor 10.

The reaction testing module 20 may additionally or alternatively enable analysis of the catalyst of the test reactors 23 to be performed at a remote location by removal of the test reactors 23 from the reaction testing module 20.

The analysis of the catalyst may comprise elemental analysis of the catalyst to identify build-up of poisons on the catalyst.

The test reactors 23 may be arranged in parallel and a selected test reactor 23 may be periodically removed to enable trends in poison build-up on the catalyst to be identified. For example, a test reactor 23 may be removed, for example, once a month to permit trends over a 6-month period to be analysed. The period between removals may be selected as desired. Replacement test reactors 23 may be inserted into the reaction testing module 20 to replace those removed.

Further aspects of the present disclosure are set out in the following clauses:

Clause 1. A chemical reactor system comprising:
a) a main reactor comprising:
   i) a reaction chamber containing catalyst,
   ii) an inlet for feeding feedstock gas from a feedstock source into the reaction chamber to contact the catalyst, and
   iii) an output for reaction products produced in the reaction chamber from reaction of the feedstock gas in the presence of the catalyst;
and
b) a reaction testing module comprising:
   i) an inlet configured to receive feedstock gas from the same feedstock source supplying feedstock gas to the main reactor, and
   ii) at least one test reactor in fluid communication with the inlet and each comprising a reaction chamber containing catalyst.

Clause 2. The chemical reactor system of clause 1, wherein the reaction testing module further comprises:
iii) an analyser configured to determine a level of catalytic activity of the catalyst within the at least one test reactor by analysis of gas exiting or derived from the reaction chamber of the at least one test reactor.

Clause 3. The chemical reactor system of clause 2, wherein the analyser comprises a mass spectrometer or gas chromatograph.

Clause 4. The chemical reactor system of clause 2 or clause 3, wherein the analyser is configured to generate an alert on detection of a decrease in the level of catalytic activity of the catalyst within the at least one test reactor indicative of poisoning of the catalyst within the at least one test reactor.

Clause 5. The chemical reactor system of clause 4, wherein the chemical reactor system further comprises a controller configured to take corrective action on generation of the alert by the analyser.

Clause 6. The chemical reactor system of clause 5, wherein the corrective action comprises altering a composition of the feedstock gas, decreasing a flow rate of the feedstock gas into the reaction chamber of the main reactor, or preventing feeding of the feedstock gas into the reaction chamber of the main reactor.

Clause 7. The chemical reactor system of any preceding clause, wherein the reaction testing module further comprises a separator for separating the liquid and gas exiting the reaction chamber of the at least one test reactor into one or more wax and/or liquid and/or gas fractions.

Clause 8. The chemical reactor system of clause 7, wherein the wax and liquid fractions are separated into a first product stream comprising wax products and a second product stream comprising light hydrocarbon products and water.

Clause 9. The chemical reactor system of any preceding clause, wherein the catalyst in the reaction chamber of the at least one test reactor is the same catalyst as present in the reaction chamber of the main reactor.

Clause 10. The chemical reactor system of any one or clauses 1 to 8, wherein the catalyst in the reaction chamber of the at least one test reactor is one or more different catalysts to that present in the reaction chamber of the main reactor.

Clause 11. The chemical reactor system of any preceding clause, wherein the at least one test reactor comprises a plurality of test reactors arranged in parallel.

Clause 12. The chemical reactor system of clause 11, wherein each of the plurality of test reactors is removable from the reaction testing module while a remainder of the plurality of test reactors remains in operation.

Clause 13. The chemical reactor system of clause 11 or clause 12, wherein the at least one test reactor comprises three, four, five, six or more test reactors.

Clause 14. The chemical reactor system of any preceding clause, wherein each of the at least one test reactors comprises a micro-reactor having:
i) a reaction chamber volume less than 250 cm³, optionally less than 200 cm³, optionally less than 150 cm³, optionally less than 100 cm³, optionally less than 50 cm³; and/or
ii) a reaction chamber containing less than 25 grams of catalyst, optionally less than 20 g of catalyst, optionally less than 15 g of catalyst, optionally less than 10 g of catalyst, optionally less than 5 g of catalyst.

Clause 15. The chemical reactor system of any preceding clause, wherein the reaction testing module further comprises a heated chamber housing the at least one test reactor.

Clause 16. The chemical reactor system of any preceding clause, wherein the reaction testing module is configured as a sidestream unit arranged in parallel to a gas flow path through the main reactor.

Clause 17. The chemical reactor system of any preceding clause, further comprising a flow splitter downstream of the feedstock source and upstream of the main reactor, the flow splitter receiving the feedstock gas from the feedstock source; the flow splitter comprising a first outlet for feeding the reaction chamber of the main reactor and a second outlet for feeding the at least one test reactor of the reaction testing module.

Clause 18. The chemical reactor system of any preceding clause, wherein the reaction testing module is configured to combine gas exiting the reaction testing module with gas exiting the main reactor at a point downstream of the reaction chamber of the main reactor, such that gas passing through the reaction testing module by-passes at least the reaction chamber of the main reactor.

Clause 19. The chemical reactor system of any preceding clause, wherein the main reactor is a Fischer Tropsch reactor containing a Fischer Tropsch catalyst.

Clause 20. A method for detecting poisoning of a catalyst in a reaction chamber, the method comprising:
a) operating a main reactor, comprising the reaction chamber containing the catalyst, by passing feedstock gas through the reaction chamber to contact the catalyst to produce reaction products from reaction of the feedstock gas in the presence of the catalyst;
b) simultaneously operating a reaction testing module by passing feedstock gas through at least one test reactor of the reaction testing module, each test reactor comprising a reaction chamber containing catalyst; and
c) using an analyser to determine a level of catalytic activity of the catalyst within the at least one test reactor by analysis of gas exiting or derived from the reaction chamber of the at least one test reactor and/or analysis of the catalyst of the at least one test reactor.

Clause 21. The method of clause 20, wherein the feedstock gas feeding the reaction chamber of the main reactor and the feedstock gas feeding the at least one test reactor of the reaction testing module are from the same feedstock source.

Clause 22. The method of clause 21, wherein a gas flow from the feedstock source is split into a first flow that feeds the reaction chamber of the main reactor and a second flow that feeds the at least one test reactor of the reaction testing module.

Clause 23. The method of any one of clauses 20 to 22, wherein analysis of the gas exiting or derived from the reaction chamber of the at least one test reactor is carried out in real time during operation of the main reactor.

Clause 24. The method of any one of clauses 20 to 23, wherein the analysis of the gas exiting or derived from the reaction chamber of the at least one test reactor is performed by a mass spectrometer or gas chromatograph.

Clause 25. The method of any one of clauses 20 to 24, wherein the gas exiting or derived from the reaction chamber of the at least one test reactor is dried and/or cooled before being passed to the mass spectrometer or gas chromatograph.

Clause 26. The method of any one of clauses 20 to 25, further comprising generating an alert on detection of a decrease in the level of catalytic activity of the catalyst within the at least one test reactor indicative of poisoning of the catalyst within the at least one test reactor.

Clause 27. The method of clause 26, further comprising taking corrective action on generation of the alert by the analyser.

Clause 28. The method of clause 27, wherein the corrective action comprises altering a composition of the feedstock gas, decreasing a flow rate of the feedstock gas into the reaction chamber of the main reactor, or preventing feeding of the feedstock gas into the reaction chamber of the main reactor.

Clause 29. The method of any one of clauses 20 to 28, wherein the catalyst in the reaction chamber of the at least one test reactor is the same catalyst as present in the reaction chamber of the main reactor.

Clause 30. The method of any one of clauses 20 to 28, wherein the catalyst in the reaction chamber of the at least one test reactor is one or more different catalysts to that present in the reaction chamber of the main reactor.

Clause 31. The method of any one of clauses 20 to 30, wherein the at least one test reactor comprises a plurality of test reactors arranged in parallel.

Clause 32. The method of any one of clauses 20 to 31, wherein analysis of the catalyst of the at least one test reactor is performed at a remote location by removal of the test reactor from the reaction testing module.

Clause 33. The method of clause 32, wherein the analysis of the catalyst comprises elemental analysis of the catalyst to identify build-up of poisons on the catalyst.

Clause 34. The method of any one of clauses 20 to 33, wherein the at least one test reactor comprises a plurality of test reactors arranged in parallel and the analysis of the catalyst comprises periodic removal of successive test reactors to enable trends in poison build-up on the catalyst to be identified.

Clause 35. The method of any one of clauses 20 to 34, further comprising heating the at least one test reactor in a heated chamber.

Clause 36. The method of any one of clauses 20 to 35, wherein the main reactor is a Fischer Tropsch reactor containing a Fischer Tropsch catalyst.

Clause 37. A reaction testing module configured for connection to a feedstock source of a main reactor, the reaction testing module comprising:
i) an inlet configured to receive feedstock gas from the feedstock source; and
ii) a plurality of test reactors in fluid communication with the inlet and arranged in parallel, each test reactor comprising a reaction chamber containing catalyst.

Clause 38. The reaction testing module of clause 37, further comprising an analyser configured to determine a level of catalytic activity of the catalyst within the plurality of test reactors by analysis of gas exiting the reaction chambers the plurality of test reactors.

Clause 39. The reaction testing module of clause 37 or clause 38, wherein the reaction resting module further comprises a heated chamber housing the at least one test reactor.

Clause 40. The reaction testing module of any one of clauses 37 to 39, wherein the catalyst in each of the reaction chambers is a Fischer Tropsch catalyst.

Clause 41. A micro-reactor configured to be removably inserted into a reaction testing module, the micro-reactor comprising:
i) a reaction chamber volume less than 250 cm³, optionally less than 200 cm³, optionally less than 150 cm³, optionally less than 100 cm³, optionally less than 50 cm³; and/or
ii) a reaction chamber containing less than 25 grams of catalyst, optionally less than 20 g of catalyst, optionally less than 15 g of catalyst, optionally less than 10 g of catalyst, optionally less than 5 g of catalyst.

Clause 42. The micro-reactor of clause 41, wherein the reaction chamber has a length of 30 to 120 cm and/or a diameter of 5 to 20 mm.

Clause 43. The micro-reactor of clause 41 or clause 42, wherein the catalyst in the reaction chamber is a Fischer Tropsch catalyst.

Clause 44. The micro-reactor of any one of clauses 41 to 43, wherein the reaction chamber of the micro-reactor is pre-charged with the catalyst and sealed prior to insertion the reaction testing module.

1.-10. (canceled)

11. A method for detecting poisoning of a catalyst in a reaction chamber, the method comprising:
a) operating a main reactor, comprising the reaction chamber containing the catalyst, by passing feedstock gas through the reaction chamber to contact the catalyst to produce reaction products from reaction of the feedstock gas in the presence of the catalyst;
b) simultaneously operating a reaction testing module by passing feedstock gas through at least one test reactor of the reaction testing module, each test reactor comprising a reaction chamber containing catalyst; and
c) using an analyser to determine a level of catalytic activity of the catalyst within the at least one test reactor by analysis of gas exiting or derived from the reaction chamber of the at least one test reactor and/or analysis of the catalyst of the at least one test reactor,
wherein the main reactor is a Fischer Tropsch reactor containing a Fischer Tropsch catalyst.

12. The method of claim 11, wherein the feedstock gas feeding the reaction chamber of the main reactor and the feedstock gas feeding the at least one test reactor of the reaction testing module are from the same feedstock source.

13. The method of claim 11, wherein analysis of the gas exiting or derived from the reaction chamber of the at least one test reactor is carried out in real time during operation of the main reactor.

14. The method of claim 11, further comprising generating an alert on detection of a decrease in the level of catalytic activity of the catalyst within the at least one test reactor indicative of poisoning of the catalyst within the at least one test reactor.

15. The method of claim 14, further comprising taking corrective action on generation of the alert by the analyser;
wherein the corrective action comprises altering a composition of the feedstock gas, decreasing a flow rate of the feedstock gas into the reaction chamber of the main reactor, or preventing feeding of the feedstock gas into the reaction chamber of the main reactor.

16. The method of claim 11, wherein the at least one test reactor comprises a plurality of test reactors arranged in parallel.

17. The method of claim 11, wherein analysis of the catalyst of the at least one test reactor is performed at a remote location by removal of the test reactor from the reaction testing module.

18. The method of claim 17, wherein the analysis of the catalyst comprises elemental analysis of the catalyst to identify build-up of poisons on the catalyst.

19. The method of claim 11, wherein the at least one test reactor comprises a plurality of test reactors arranged in parallel and the analysis of the catalyst comprises periodic removal of successive test reactors to enable trends in poison build-up on the catalyst to be identified.
